(19) United States
(12) Patent Application Publication
(10) Pub. No.: US 2008/0179137 A1
(43) Pub. Date: Jul. 31, 2008

(54) Pre-compressed gas strut, use thereof for installing attic ladder and attic ladder having pre-compressed gas strut

(75) Inventors: Brett A. Latimer, New Castle, PA (US); Robert D. Beggs, Stoneboro, PA (US)

Correspondence Address: MCDERMOTT WILL & EMERY LLP, 600 13TH STREET, N.W., WASHINGTON, DC, 20005-3096, US

(73) Assignee: WERNER CO.

(21) Appl. No.: 12/007,193

(22) Filed: Jan. 8, 2008

Related U.S. Application Data
(60) Provisional application No. 60/879,356, filed on Jan. 9, 2007.

(51) Int. Cl. E06C 9/08; F16F 9/02

(52) U.S. Cl. 182/77; 267/118

(57) ABSTRACT

A pre-compressed gas strut assembly and method of installing it for use as the extension and retraction part of a folding ladder configured for installation in an opening, such as an opening in a ceiling of a house or other building. The pre-compressed gas strut has holding members attached to end caps having radial protrusions arranged on opposite ends of the gas strut that maintain the gas strut in a compressed position during installation of the attic ladder assembly.

### RELATED APPLICATION

This application claims the priority of Provisional Application No. 60/879,356 filed Jan. 9, 2007.

### TECHNICAL FIELD

This disclosure relates to a pre-compressed gas strut assembly and method of installing thereof for use as the extension and retraction part of a folding ladder configured for installation in an opening, such as an opening in a ceiling of a house or other building. The disclosure particularly relates to a pre-compressed gas strut with holding members that maintain the gas strut in a compressed position to allow for easier installation of the ladder assembly.

### BACKGROUND

Attic ladders are used for the purpose of granting access to areas above or below a room or floor in which limited space is available. One key feature of the attic ladder is its ability to fold or retract upward into the ceiling in order to take up no floor space except when extended. Other advantages to the use of attic ladders are the low cost and ease of manufacturing relative to typical fixed stairways.

Examples of attic ladders or “disappearing stairways” are shown, for example, in U.S. Pat. Nos. 2,649,237 and 2,852,176. These ladders normally fold and retract upwardly into a frame secured between adjacent joists of the attic, and the folded ladder is covered by a door which normally extends substantially flush with the finished ceiling of the room in which the ladder is mounted.

U.S. Pat. No. 4,281,743 issued to Fuller on Aug. 4, 1981 shows another conventional attic ladder. As shown in FIGS. 1A and 1B, attic ladder 111 includes an outside frame 112 mounted between adjacent floor joists 113 of the attic floor 114. Cross braces 115 are mounted between a pair of adjacent floor joists 113 to provide end support for the frame 112 of the ladder. Ladder 111 is mounted in the ceiling by securing frame 112 to the joists 113 and the cross braces 115. A cover panel 116 forms part of ladder 111 and is hinged to the outer frame 112, so that the door becomes substantially flush with the ceiling 119 when the ladder 111 is folded. A first ladder portion 117 is affixed to the inner face of cover panel 116 and a second ladder portion 118 is pivotally hinged to the first ladder portion so as to be unfolded or folded when the ladder is opened or closed. While commercially available attic ladders or disappearing stairways typically come in a number of sizes, most come in several standard widths and lengths adaptable to fit conventional constructions.

U.S. Pat. No. 4,541,508 shows yet another conventional attic ladder. In FIG. 2, a foldable ladder is shown to consist of a lower section 211, a central section 212 and an upper section 213. The central section 212 is hingedly connected to the two remaining sections 211, 213 by a hinge so that the central section 212 and the lower section 211 can be folded up on the upper section 213. Upper section 213 is hingedly attached to a frame 214 by hinges 215, with the folding down movement of the upper ladder section 213 being limited by a pair of toggle joints 216 attached to the upper ladder section and to the frame 214. Toggle joints 216 are rigidly connected to each other at the lower arms by means of an axle 218 extending in parallel with the rungs of the ladder and are attached to the axle outside the side rails of the ladder. The ladder is spring-biased to a closed position by a gas spring 219 connected at one end to an outside of one side rail and connected at its other end, via piston rod 219a, to moment arm 218a, which is rigidly connected to the axle 218 at such an angle that a maximum moment is generated when the door is almost entirely closed. When the point of connection between the gas spring 219 and the moment arm 218a has passed the line for moment center (i.e. the connecting line between the attachment of the gas spring 219 to the ladder 213 and the axle 218, which passing takes place when the door is opened entirely), the gas spring 219 actuates the door so that it is locked in folded-down position, which is necessary because the “weight” of the door decreases as soon as the ladder sections are folded out.

U.S. Pat. No. 7,165,649 describes a positioning system for a folding ladder that utilizes struts to control the force required to open or close the folding ladder. To attach the struts, a proximal or base end (i.e., a larger diameter end) of each strut is snapped into place over a respective post ball joint located on a side of the ladder assembly. A distal or terminal end of each strut is attached to the rack plate 610 ball socket 623 that slides inside the frame side plate 230 (such as shown in FIGS. 4 and 5). Once the strut has been attached, a wrench (e.g., a ⅞″ wrench) is used to turn the gear 615 until the strut is compressed, with the rack plate 610 snapped into its fourth and final position. For example, if looking at the head plate 210 of the support frame 200, the gear 615 on the left frame side plate 230 will be turned in a counter-clockwise direction, while the gear 615 on the right frame side plate 230 will be turned in a clockwise direction.

Rack plate 610 and ratchet system 620 are configured to sequentially encounter, deflect, and pass over each of the tabs 201 as the strut is compressed. The tabs 201 serve as backstops or locks against inadvertent and sudden extension by the strut, which could otherwise cause injury to the installer or damage to the folding ladder 100 or related components. Once the strut has been substantially fully compressed, in a location corresponding to the fourth tab 201, the rack plate 610 may then be secured to the support frame side 230, such as by a ¼″×1½″ lag screw through a hole on the rack 610 above the ratchet system and into the wood joist.

The proximal end of each strut is adapted to slide, by virtue of the post, within the attachment slot in the curved bracket 216 and the distal end of each strut is fixed in the configuration noted above. Thus, the struts are initially installed in the fully open position with a distal end of each gas strut attached to ratchet system 620 ball socket 623 and a proximal end of each gas strut to a bracket attached to a ladder rail, whereafter the strut may then be compressed to a set final position.

Without the above-described positioning system, a folding ladder employing a gas strut would require a strut distal end to be fixed to the support frame through a suitable connection and the strut proximal end to be secured to the ladder. Such folding ladder configuration would have to be installed at a position rotated backward substantially past its 90° resting position to place the system in the proper position to rotate the ladder back sufficiently to compress the strut. The need to rotate the entire ladder assembly in this manner would require a substantial amount of open space around where the folding ladder is to be installed, which would be detrimental to some space-limited applications.

Generally speaking, the strut is used to control the force required to open or close the folding ladder. The strut, which maintains a fully open position unless forced into compression, provides several advantages over the common lever and spring mechanisms used in attic ladders (e.g., occupying less space) and confers a smooth force distribution and permits improved control over the force and velocity of the ladder during opening or closing. The strut also reduces the amount of space needed for a folding ladder, which in turn allows for wider steps on the ladder and provides a larger grip area on the ladder rails. However, the positioning system disclosed in the '649 patent requires added space and an additional step of compressing the strut to the closed retracted position.

### SUMMARY

To overcome the above-mentioned problems associated with the installation of an attic ladder, an aspect of the present invention is a pre-compressed gas strut comprising a cylindrical housing having an opening at a terminal end, and a piston rod, a portion of which fits inside the cylindrical housing. The piston rod is capable of being projected outwardly from the opening of the cylindrical housing. An end cap is on a terminal end of the cylindrical housing opposite to the terminal end having the opening. An end cap is on the terminal end of the piston rod located outside the cylindrical housing. The end caps have at least one protrusion that protrudes in a direction substantially radially from the axis of the gas strut. A holding member comprises at least one strap having an opening on each end capable of fitting around said protrusion. The holding member holds the gas strut in a compressed position by preventing the piston rod from protruding outwardly from the cylindrical housing.

Another aspect of the present invention is a method of mounting an attic ladder comprising the step of attaching a pre-compressed gas strut to a mounting plate and a ladder frame hinge mount. The mounting plate and the ladder frame hinge mount communicate with the attic ladder frame, while an attic ladder door assembly is in a partially-open position. The gas strut comprises a cylindrical housing having an opening at a terminal end, a piston rod, a portion of which fits inside the cylindrical housing. The piston rod is capable of being projected outwardly from the opening of the cylindrical housing. An end cap is on a terminal end of the cylindrical housing opposite to the terminal end having the opening. An end cap is on the terminal end of the piston rod located outside the cylindrical housing. The end caps have at least one protrusion that protrudes in a direction substantially radially from the axis of the gas strut. A holding member comprising at least one strap having an opening on each end capable of fitting around the protrusion. The holding member holds the gas strut in a compressed position by preventing the piston rod from protruding outwardly from the cylindrical housing. The attic ladder door assembly is subsequently opened to a fully open position such that the at least one strap holding the gas strut in the compressed position becomes disengaged from the protrusion of the end caps, and is removed.

Another aspect of the present invention is an attic ladder and having a gas strut comprising a cylindrical housing having an opening at a terminal end, a piston rod, a portion of which fits inside the cylindrical housing. The piston rod is capable of being projected outwardly from the opening of the cylindrical housing. An end cap is on a terminal end of the cylindrical housing opposite to the terminal end having the opening. An end cap is on the terminal end of the piston rod located outside the cylindrical housing. The end caps have at least one protrusion that protrudes in a direction substantially radially from the axis of the gas strut.

One advantage in using the pre-compressed gas-strut is that it eliminates the need for a positioning rack, thereby using less space on the attic ladder frame.

Additional advantages will become readily apparent to those skilled in this art from the following detailed description, wherein only preferred aspects of the present invention are shown and described. As will be realized, the disclosed invention includes other and different embodiments, and its several details are capable of modifications in various obvious respects, all without departing from the spirit thereof. Accordingly, the drawings and description are to be regarded as illustrative in nature, and not as restrictive.

### BRIEF DESCRIPTION OF THE DRAWINGS

Reference is made to the attached drawings, wherein elements having the same reference numeral designations represent like elements throughout, and wherein:

FIGS. 1 and 2 are perspective views of a conventional folding ladder disposed in an attic;

FIG. 3 is a perspective view of another conventional folding ladder disposed in an attic;

FIG. 4 is a perspective view of the support frame in accord with another conventional folding ladder.

FIG. 5 is an exploded isometric view of Detail F of the ratchet system of the gas-strut positioning system shown in FIG. 4.

FIGS. 6A and 6B are a top and side views of the gas-strut in accord with the present invention.

FIGS. 7A, 7B and 7C are side and top views of the end portion of the gas-strut in accord with an embodiment of the present invention.

FIGS. 8A and 8B are top and side views of a strap in accord with an embodiment of the present invention.

FIG. 9 is a side-perspective view of a pre-installation view of a ladder utilizing the gas-strut in accord with an embodiment of the present invention.

FIG. 10 is an exploded side-perspective view of a pre-installation position of the gas-strut in accord with an embodiment of the present invention.

FIG. 11 is a side-perspective view of the ladder with the gas-strut installed according to an embodiment of the present invention.

FIG. 12 is an exploded side-perspective view of the ladder with the gas-strut installed according to an embodiment of the present invention.

FIG. 13 is a side-perspective view of the ladder with the gas-strut installed showing the removal of the straps according to an embodiment of the present invention.

FIG. 14 is an exploded side-perspective view of the ladder with the gas-strut installed showing the removal of the straps according to an embodiment of the present invention.

FIG. 15 is a side-perspective view of the ladder with the gas-strut installed and the straps removed according to an embodiment of the present invention.

FIG. 16 is an exploded side-perspective view of the ladder with the gas-strut installed and the straps removed according to an embodiment of the present invention.

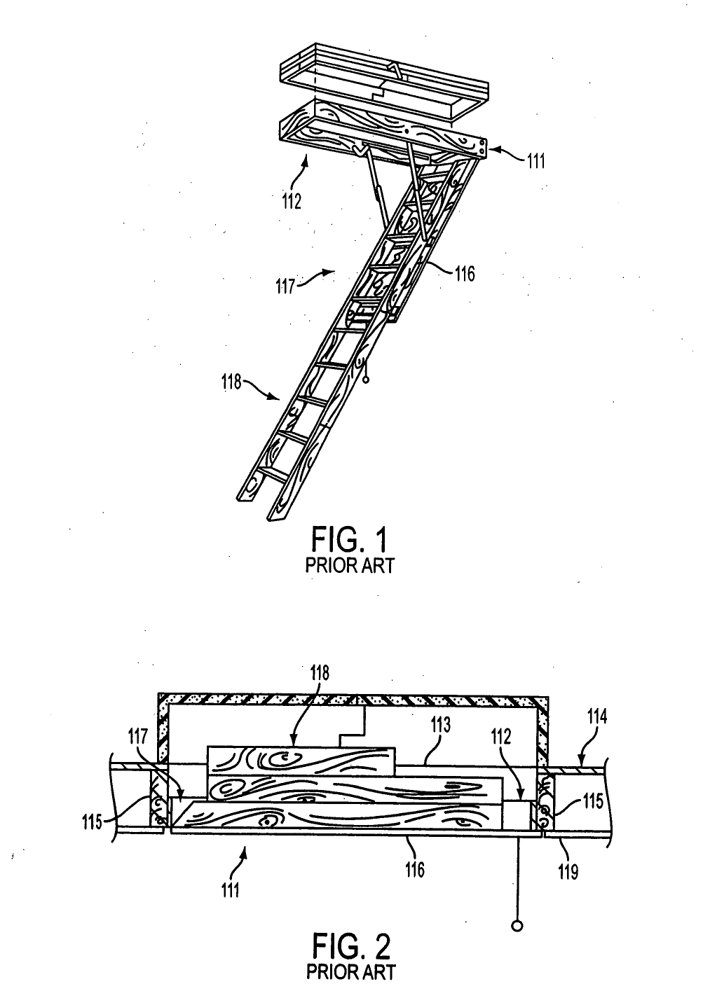

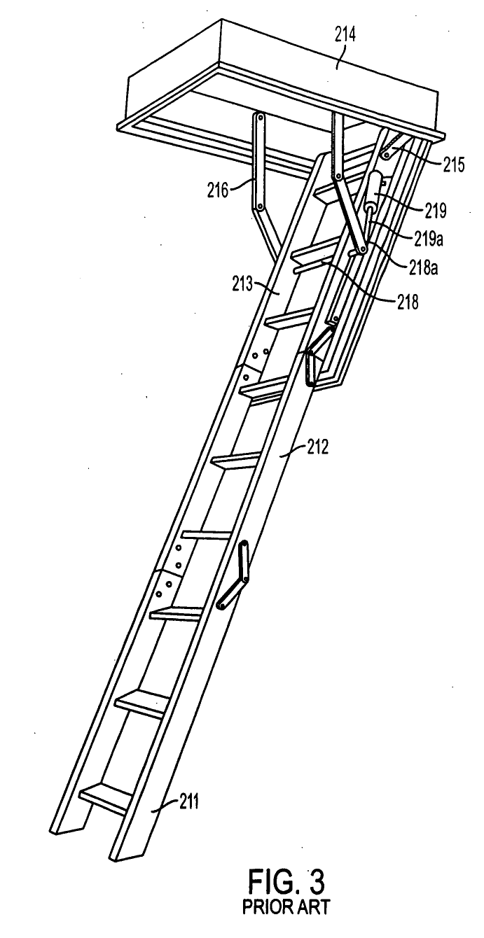

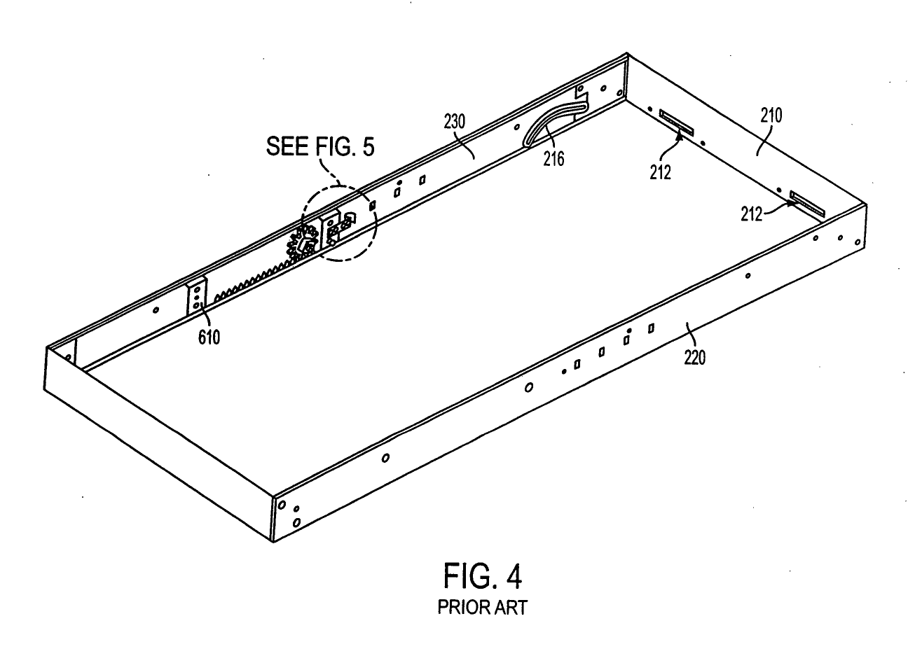

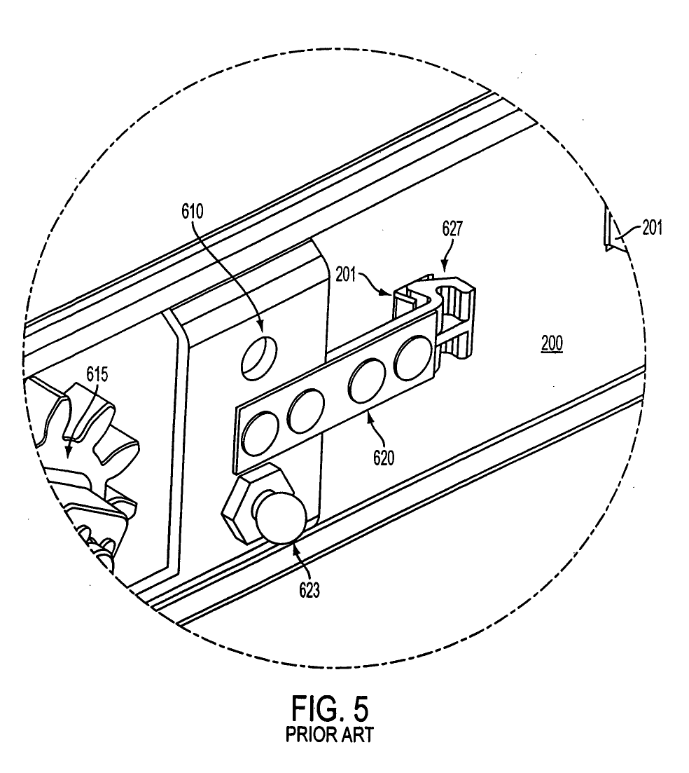

### DETAILED DESCRIPTION

With reference to the attached drawings, there is described a pre-compressed gas-strut and a method using the gas-strut to install an attic ladder.

In one embodiment, the pre-compressed gas strut comprises a cylindrical housing having an opening at a terminal end, and a piston rod, a portion of which fits inside the cylindrical housing, wherein the piston rod is capable of being projected outwardly from the opening of the cylindrical housing. An end cap is on a terminal end of the cylindrical housing opposite to the terminal end having the opening and an end cap is on the terminal end of the piston rod located outside the cylindrical housing. The end caps have at least one protrusion that protrudes in a direction substantially radially from the axis of the gas strut. A holding member comprises at least one strap having an opening on each end capable of fitting around said protrusion, wherein the holding member holds the gas strut in a compressed position by preventing the piston rod from protruding outwardly from the cylindrical housing.

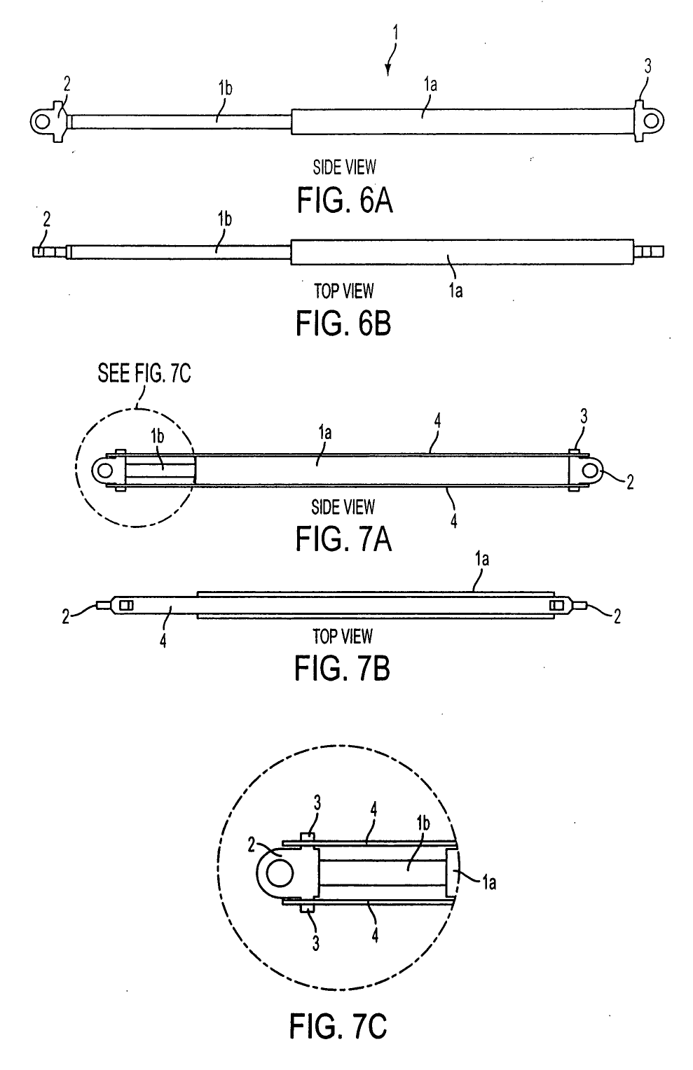

FIGS. 6A and 6B show a gas-strut of one embodiment of present invention in the non-compressed position. The gas-strut 1 is comprised of a cylindrical housing 1a having a piston rod 1b which fits inside the cylindrical housing 1a. The piston rod 1b is projected outwardly from an opening at one end of the cylindrical housing 1a as a result of a compressed gas contained therein. Attached to opposing ends of the cylindrical housing 1a and the piston rod 1b are end caps 2, each of which is comprised of at least one protrusion 3 which protrudes in a direction substantially radially from the lengthwise axis of the gas strut.

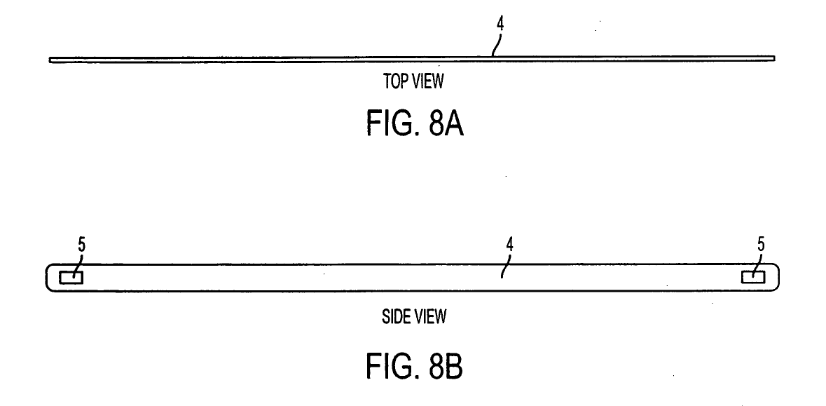

FIGS. 7A, 7B and 7C show a gas-strut of one embodiment of present invention in the pre-compressed positions. In this figure, the strap 4 is attached to the gas strut via the openings 5 (shown in FIG. 8) encompassing the protrusions 3. The strap 4 has openings 5 at both ends such that the openings may fit over the protrusions 3 of the end caps 2.

In one aspect of the gas strut described above, the holding portion comprises two straps and each end cap has two protrusions 3.

In another aspect of the gas strut described above, the at least one strap is comprised of a rigid material. Suitable rigid materials for the strap include metals, plastics, wood or ceramics.

In a certain aspect of the gas strut described above, the rigid material is a metal. Suitable metals for the strap include steel and aluminum.

In another aspect of the gas strut described above, the at least one strap is comprised of a flexible high tensile strength material. Suitable flexible high tensile strength materials include rubbers and reinforced synthetic polymers.

In a certain aspect of the gas strut described above, the flexible material is a rubber.

In a certain aspect of the invention, the opening in the strap is shaped as a slot.

Also described herein is a method of mounting an attic ladder comprising attaching a pre-compressed gas strut to a mounting plate and a ladder frame hinge mount. The mounting plate and the ladder frame hinge mount communicates with the attic ladder frame, while an attic ladder door assembly is in a partially-open position. The gas strut comprises a cylindrical housing having an opening at a terminal end, a piston rod, a portion of which fits inside the cylindrical housing. The piston rod is capable of being projected outwardly from the opening of the cylindrical housing. An end cap is on a terminal end of the cylindrical housing opposite to the terminal end having the opening. An end cap is on the terminal end of the piston rod located outside the cylindrical housing. The end caps have at least one protrusion that protrudes in a direction substantially radially from the axis of the gas strut. A holding member comprises at least one strap having a slot on each end capable of fitting around the protrusion. The holding member holds the gas strut in a compressed position by preventing the piston rod from protruding outwardly from the cylindrical housing. After opening the attic ladder door assembly to a fully open position, the at least one strap holding the gas strut in the compressed position becomes disengaged from the protrusions of the end caps and is removed.

In one aspect of the method described above, the holding member comprises two straps and each end cap has two protrusions.

The following portion describes the pre-compressed gas strut of one embodiment of the present invention, and a method by which the attic ladder is installed using the pre-compressed gas strut.

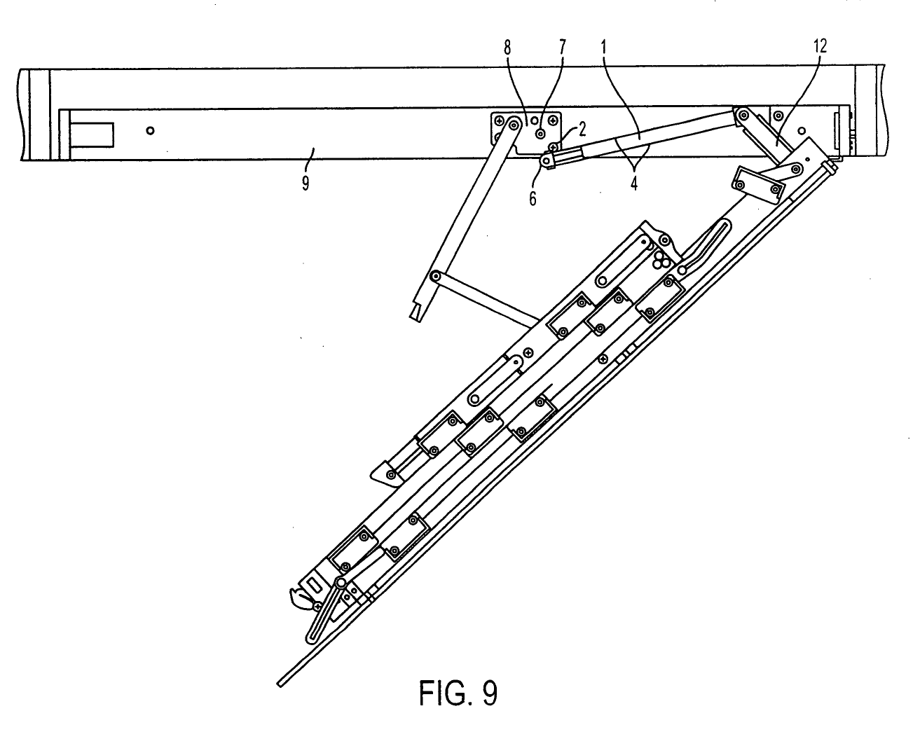

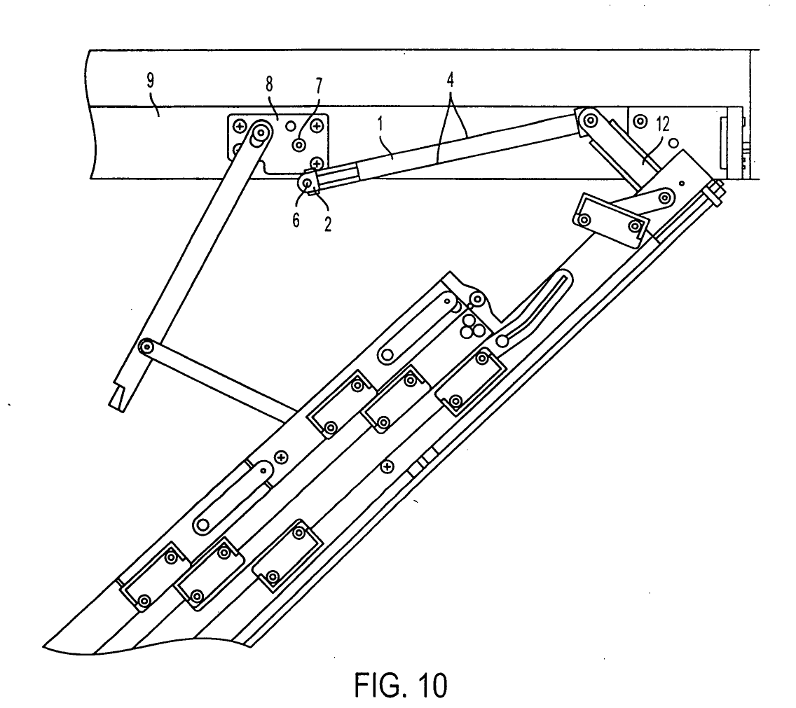

The gas-strut of the present invention can be installed as follows. FIGS. 9 and 10 show the terminal end of the pre-compressed gas-strut 1 opposite to the opening including the straps 4 attached to a ladder frame hinge mount 12 and attached to the attic ladder frame 9. The end of the gas-strut 1 that is on the side having the opening is then mounted onto the mounting plate 8 by rotating the gas-strut 1 into position to connect to the mounting plate which is also attached to the attic ladder frame 9. Each end cap 2 contains a hole 6 for assembling the gas-strut 1 to the bolt 7, which is located on the mounting plate 8.

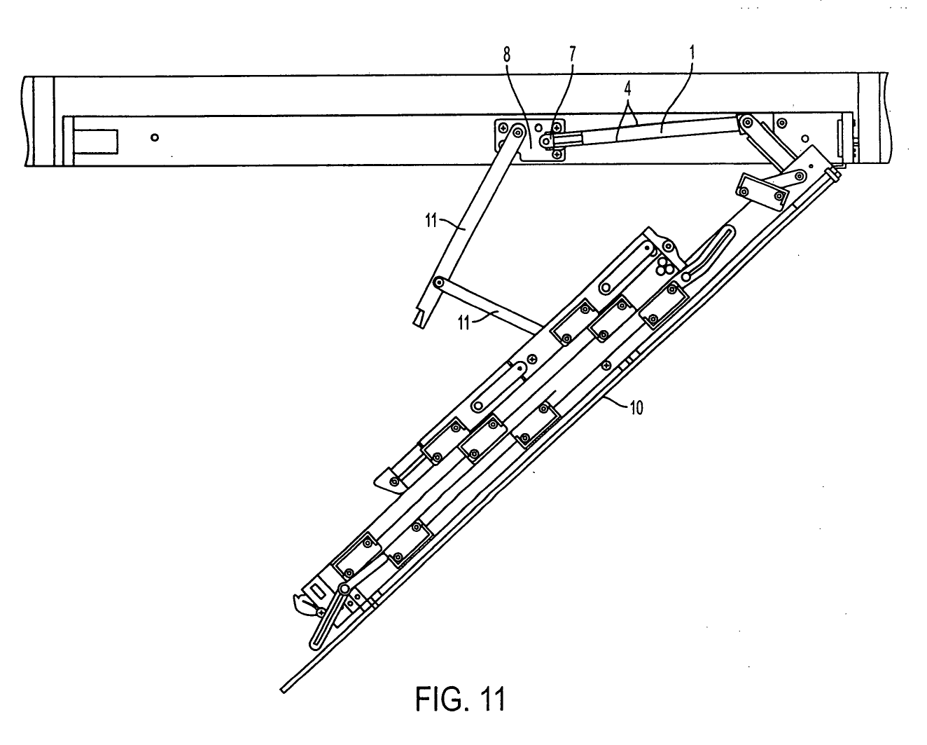

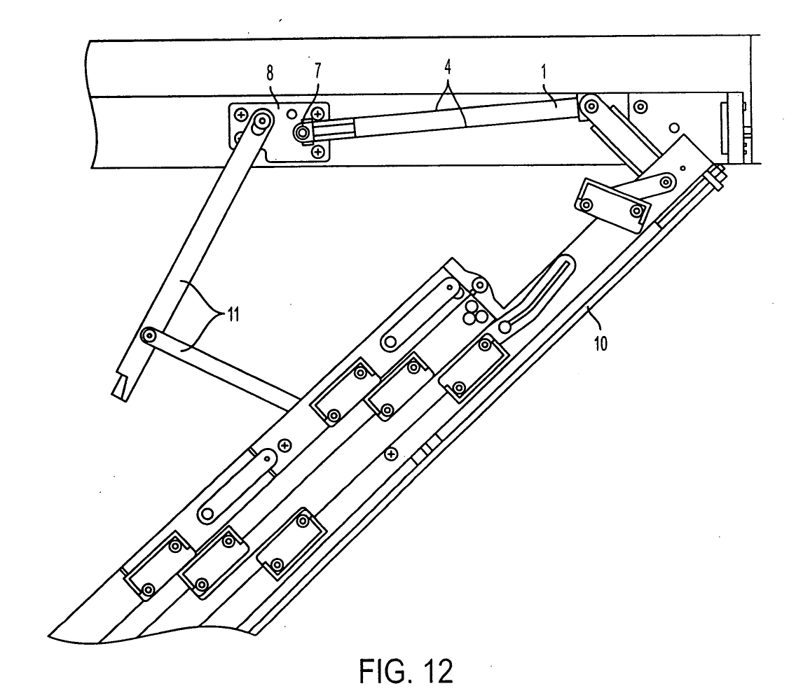

FIGS. 11 and 12 show the pre-compressed gas strut 1 in a partially open position without the support arm assembly 11 not fully engaged after having been attached to the bolt 7 on the mounting plate 8. The gas strut 1 may be held in place by any means commonly known to those skilled in the art. One preferred means of holding the gas-strut 1 in place is with a standard lock nut.

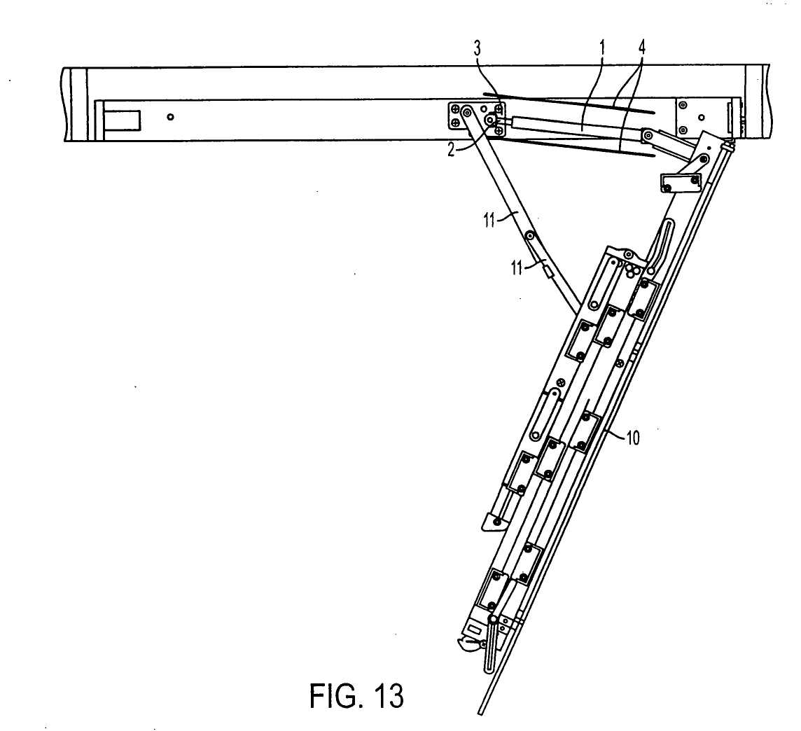

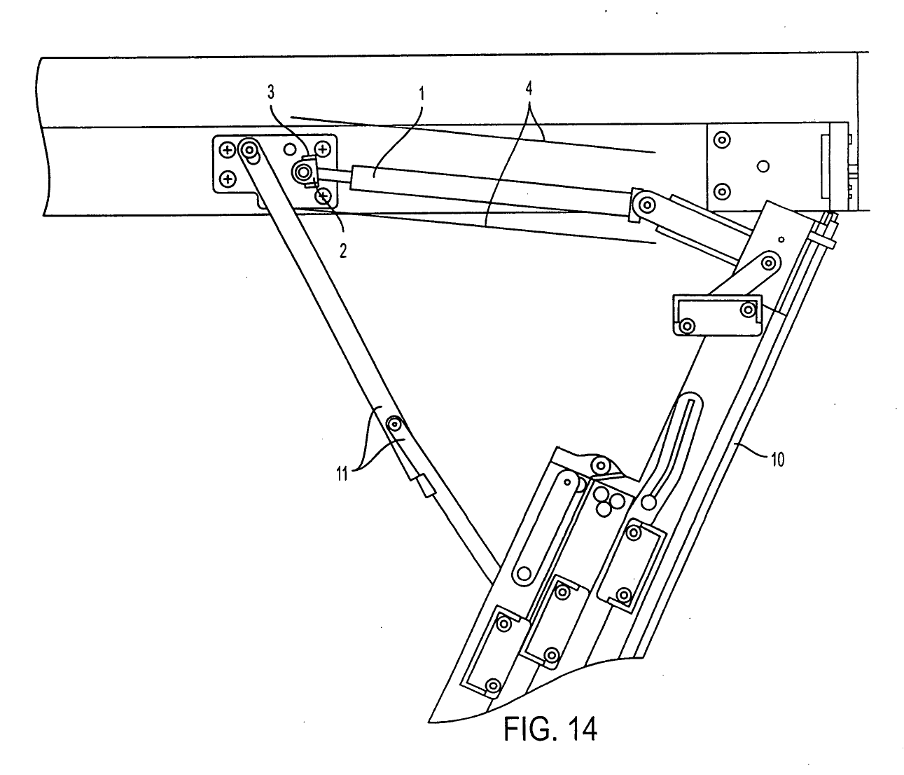

FIGS. 13 and 14 show the attic ladder door assembly 10 in the open position, where the support arm assembly 11 is fully engaged. The straps 4 on the gas strut assembly 1 become disengaged from the protrusions 3 when the attic ladder door assembly is pivoted into the fully open position. After the straps 4 become disengaged from the protrusions 3, the straps 4 may then be removed.

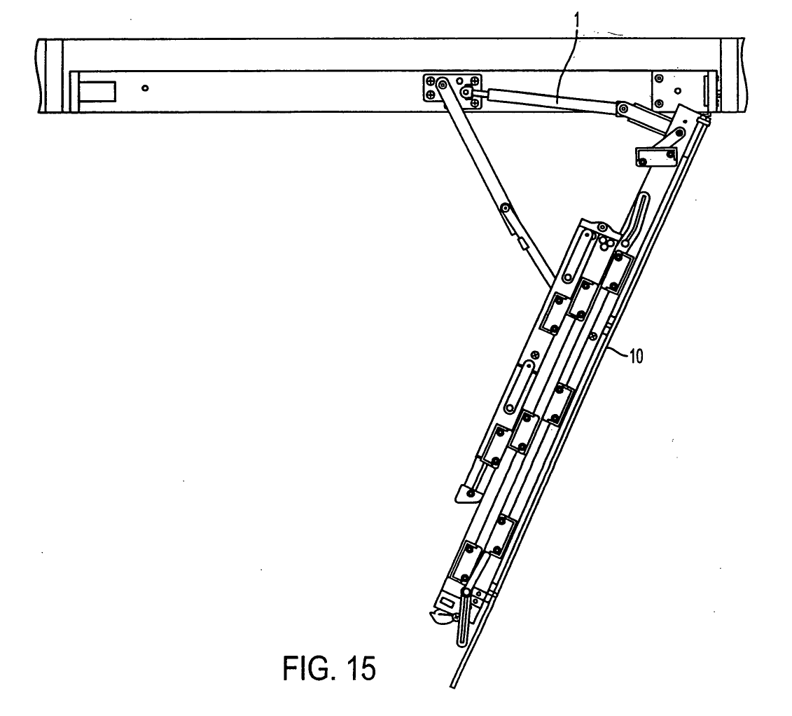

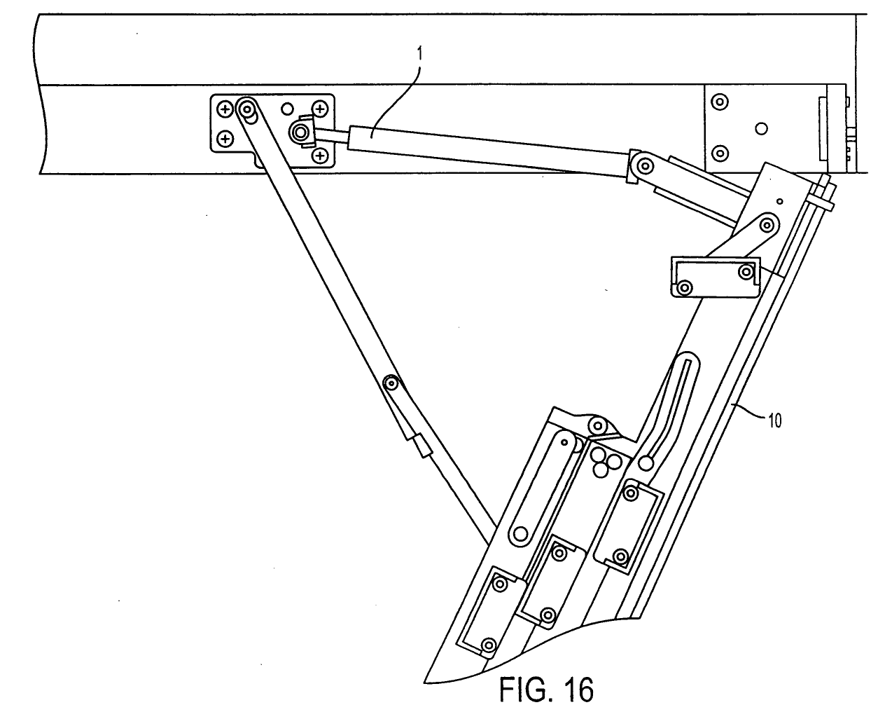

FIGS. 15 and 16 show the attic ladder door assembly 10 in the fully open position with the straps 4 completely disengaged and removed from the pre-compressed gas-strut 1. The gas-strut is fully installed once the straps 4 are removed.

In the previous descriptions, specific materials, structures, etc., are set forth to illustrate the present invention. However, it should be recognized that the present invention can be practiced without resorting to the details specifically set forth. It is to be understood that the present invention is capable of use in various other combinations and environments and is capable of changes or modifications within the scope of the inventive concepts expressed herein.

We claim:

1) A pre-compressed gas strut comprising:
a cylindrical housing having an opening at a terminal end;
a piston rod, a portion of which fits inside said cylindrical housing, wherein said piston rod is capable of being projected outwardly from said opening of said cylindrical housing;
an end cap on a terminal end of the cylindrical housing opposite to the terminal end having the opening;
an end cap on the terminal end of the piston rod located outside the cylindrical housing,
said end caps having at least one protrusion that protrudes in a direction substantially radially from the axis of the gas strut;
a holding member comprising at least one strap having an opening on each end capable of engaging said protrusion,
wherein said holding member holds the gas strut in a compressed position by preventing the piston rod from protruding outwardly from the cylindrical housing.

2) The gas strut of claim 1, wherein said holding member comprises two straps and each end cap has two protrusions.

3) The gas strut of claim 1, wherein said at least one strap is comprised of a rigid material.

4) The gas strut of claim 3, wherein said rigid material is a metal.

5) The gas strut of claim 1, wherein said at least one strap is comprised of a flexible material.

6) The gas strut of claim 5, wherein said flexible material is a rubber.

7) A method of mounting an attic ladder comprising the steps of:
(a) attaching a pre-compressed gas strut to a mounting plate and a ladder frame hinge mount, wherein said mounting plate and said ladder frame hinge mount communicate with said attic ladder frame, while an attic ladder door assembly is in a partially-open position, said gas strut comprising:
a cylindrical housing having an opening at a terminal end;
a piston rod, a portion of which fits inside said cylindrical housing, wherein said piston rod is capable of being projected outwardly from said opening of said cylindrical housing;
an end cap on a terminal end of the cylindrical housing opposite to the terminal end having the opening;
an end cap on the terminal end of the piston rod located outside the cylindrical housing,
said end caps having at least one protrusion that protrudes in a direction substantially radially from the axis of the gas strut;
a holding member comprising at least one strap having a slot on each end capable of engaging said protrusion,
wherein said holding member holds the gas strut in a compressed position by preventing the piston rod from protruding outwardly from the cylindrical housing;
(b) after step (a), removing the at least one strap by opening the attic ladder door assembly to a fully open position such that the at least one strap becomes disengaged from the protrusions.

8) The method of claim 7, wherein said holding member comprises two straps and each end cap has two protrusions.

9) The method of claim 7, wherein said at least one strap is comprised of a rigid material.

10) The method of claim 9, wherein said rigid material is a metal.

11) The method of claim 7, wherein said at least one strap is comprised of a flexible material.

12) The method of claim 11, wherein said flexible material is a rubber.

13) An attic ladder comprising:
an attic ladder door assembly;
a support arm assembly;
an attic ladder frame;
a ladder frame hinge mount; and
the pre-compressed gas strut of claim 1,
wherein the attic ladder door assembly is attached to the attic ladder frame via a first terminal end of the support arm assembly and via the ladder frame hinge mount and pre-compressed gas strut on a second terminal end of the support arm assembly.

14) The attic ladder of claim 13, wherein said holding member comprises two straps and each end cap has two protrusions.

15) The attic ladder of claim 13, wherein said at least one strap is comprised of a rigid material.

16) The attic ladder of claim 15, wherein said rigid material is a metal.

17) The attic ladder of claim 13, wherein said at least one strap is comprised of a flexible material.

18) The attic ladder of claim 17, wherein said flexible material is a rubber.
